(19) United States
(12) Patent Application Publication
(10) Pub. No.: US 2023/0330453 A1
(43) Pub. Date: Oct. 19, 2023

(54) A Respirator System

(71) Applicant: QinetiQ Limited, Hampshire (GB)

(72) Inventor: Alec Thomas Stevenson, Farnborough, Hampshire (GB)

(21) Appl. No.: 18/044,337

(22) PCT Filed: Aug. 13, 2021
(86) PCT No.: PCT/EP2021/072636

§ 371 Date: Mar. 7, 2023

(30) Foreign Application Priority Data
Sep. 7, 2020 (GB) 2014003.4
Apr. 30, 2021 (GB) 2106241.9

(51) Int. Cl. A62B 23/02; A62B 18/10

(52) U.S. Cl. CPC A62B 23/02; A62B 18/10

(57) ABSTRACT

A respirator system for delivering filtered atmospheric air to a user for inhalation, the respirator system comprising: a respirator through which a user can inhale filtered air; first and second air filter systems, each air filter system being configured to filter and draw air from the atmosphere into the respirator system and to deliver filtered drawn air to the respirator via an airflow path; first and second conduits for directing filtered air from the respective first and second air filter systems to the respirator; and a support for supporting the respirator system on the user's head, wherein the respirator is arranged at a front of the support to engage the front of a user's head when in use, and the first and second air filter systems are arranged at the rear of the support to sit at the rear of a user's head when in use, wherein the support comprises an adjusting means for adjusting a spacing between the two air filter systems to secure the support to the user's head.

### FIELD OF THE INVENTION

The present disclosure relates to a respirator system for delivering filtered atmospheric air to a user for inhalation.

### INTRODUCTION

Respiratory protection allows users to breathe atmospheric air without inhaling any potentially harmful particles such as airborne pathogens, pollution and dust that may be present in the ambient environment. A need for highly effective respiratory protection has been of the utmost importance during the COVID-19 pandemic, particularly for frontline responders working in close proximity to individuals infected, or potentially infected, with the coronavirus disease.

Respiratory Protective Equipment (RPE) must provide a high level of protection to the user, by preventing them from inhaling any potentially harmful particles in the air. The degree of protection can be quantified by the ‘protection factor’: the number of harmful particles inside the respirator when in use, as a proportion of the number of harmful particles in the atmosphere outside the respirator. This can be safely measured in a laboratory using inert particles of similar size to harmful particles.

A conventional form of respiratory protection takes the form of a negative-pressure fabric respirator that seals around a user's mouth and nose. In this form, the fabric respirator acts as a filter medium, thereby removing particles of at least a certain size—the filter allows smaller air particles to pass through to the user for inhalation, but prevents larger harmful from passing through to the user for inhalation.

High levels of respiratory protection are associated with increased breathing resistance, since the user must inhale hard to draw atmospheric air through the filter making it harder for the individual to breath in and out. Additional discomfort can be caused by heat and moisture building in the respirator (as expired air is saturated with water vapour at a temperature of between 33-37° C.).

To provide a high level of respiratory protection and to overcome some of the limitations associated with high breathing resistance, high air temperature and high humidity within a respirator, Powered Air-Purifying Respirators (PAPR) have been used. PAPRs typically include a respirator, or face mask, that is arrangeable to communicate with a user's nose and mouth, or whole face, and a fan, configured to draw air from the ambient environment through a filter and into the respirator. Such systems can offer a much higher level of protection than the conventional respirators described above. Moreover, as the fan draws air through the filter, less effort is required by the wearer to breathe and the air within the mask is maintained at a lower temperature and humidity.

However, these PAPRs have some drawbacks.

It will be appreciated that a user's inhalation profile is not constant. In particular, referring to FIG. 1, which shows how a user's inspiratory flow rate varies with time, a user inhales intermittently, such that a user's inspiratory flow rate varies between a peak inspiratory flow rate 2 (i.e. the maximum rate at which a user inhales) and a zero inspiratory flow rate 4 (e.g. while the user is exhaling, or neither inhaling nor exhaling). To provide enough air flow to the respirator to allow the user to breathe, the fan must constantly draw air into the system at a flow rate 6 which at least matches the user's anticipated peak inspiratory flow rate 2. This puts a very high demand on the fan, which therefore requires large fans and hence a large power supply, typically in the form of bulky and expensive batteries—indeed, the batteries are typically so heavy that they usually must be attached to, and supported by, the user's waist. Such respirators can therefore be impractical, bulky and cumbersome, and also noisy due to the large fans. What is more, the batteries only a have a short battery life of a few hours, after which the battery must be recharged or replaced. As a result of the costs associated therewith, such respirators have been prohibited from widespread use.

As a result of this, although PAPRs have been referred to as the ‘gold-standard’ in respiratory protection, they have severe limitations. As such, they are typically only used in situations where the risk of particle inhalation is very significant, for example in aerosol-generating procedures. Even in these cases, the cumbersome nature and short battery life of the devices may make them very impractical for use in some applications.

It will be further appreciated how much filtered air is not inhaled by users of PAPRs but is instead released to the atmosphere and hence wasted. Indeed, more than half the time, when the user is exhaling, filtered air is not required. Even when the user is inhaling, PAPRs often provide more filtered air flow that the user requires—the average flow rate of filtered air actually needed to support user respiration over a timer period can be less than a third of the user's peak inspiratory flow rate, the rate at which the fans of PAPR are configured to operate. Hence, in this way, it can be appreciated that traditional PAPRs can be inefficient, with energy being expended to draw air through filters when filtered air is not need and, even when filtered air is needed, expending energy drawing more filtered air than necessary to support breathing demand.

Some breath-responsive PAPRs are known in which fan speed is adjusted on a continuous basis; speeding up when the user breathes in and slowing down when the user breathes out. While this affords greater efficiency, it increases the complexity of the design, requiring continuous pressure monitoring, a rapidly responding fan and feedback algorithms to control the speed changes. It should be recognised that the efficiency of these devices will vary dependent on the respiratory demand of the user making it difficult to accurately predict battery run time. A further and important limitation is that these devices still require high performance fans to be able to support the high peak flow rates demanded of the wearer.

For all PAPRs it is important that the device has a good fit to the user: this is important for comfort and also in providing effective sealing around a user's airways to avoid contamination. It is also important that the device is easy to put on and take off as it is used.

The system and method according to the present invention aims to solve at least some of the problems associated with the prior art.

### SUMMARY OF THE INVENTION

Against this background, the invention resides in a respirator system for delivering filtered atmospheric air to a user for inhalation, the respirator system comprising: a respirator through which a user can inhale filtered air; first and second air filter systems, each air filter system being configured to filter and draw air from the atmosphere into the respirator system and to deliver filtered drawn air to the respirator via an airflow path; first and second conduits for directing filtered air from the respective first and second air filter systems to the respirator; and a support for supporting the respirator system on the user's head, wherein the respirator is arranged at a front of the support to engage the front of a user's head when in use, and the first and second air filter systems are arranged at the rear of the support to sit at the rear of a user's head when in use, wherein the support comprises an adjusting means for adjusting a spacing between the two air filter systems to secure the support to the user's head.

The adjusting means preferably comprises one or more straps of adjustable length.

The adjusting means may comprise a clasp for disconnecting and reconnecting the support between the first and second air filter systems.

This respirator system is preferably for use by medical personnel and/or for providing protection against particulates associated with industrial works.

According to a further aspect of the invention, there is provided a respirator system for delivering filtered atmospheric air to a user for inhalation. The respirator system comprises: a respirator through which a user can inhale filtered air at an inspiratory flow rate; an air filter system for filtering and drawing air from the atmosphere into the respirator system at a base flow rate and delivering filtered drawn air to the respirator; and a reservoir for storing filtered air. The air filter system is arranged in fluid communication with the reservoir and the respirator such that: when the user's inspiratory flow rate is lower than the base flow rate of the filter system, at least a portion of the filtered air entering the respirator system is stored in the reservoir; and when the user's inspiratory flow rate exceeds the base flow rate of the air filter system, filtered air stored in the reservoir is drawn into the respirator for inhalation to supplement the filtered air provided by the filter system.

This system allows the air filter system to run at a flow rate that is lower than a user's peak inspiratory flow rate, while still supplying adequate air to the user for peak inhalation. When the user's inspiratory rate is less than the base flow rate, surplus air drawn by the air filter unit is stored in the reservoir. When the inspiratory rate exceeds the base flow rate, stored air from the reservoir supplements the air drawn by the air filter system to supply sufficient air for the user's needs.

The respiratory system affords two primary benefits.

First by storing filtered air during the exhalation phase of the breathing cycle and during periods when inhalation demand is lower than the base flow rate, the user's breathing demands can be met using much lower fan flow rates than traditional PAPRs. This in turn allows the fan and power supply to be smaller, lighter, more compact and inexpensive. In these ways, it can be understood how the present invention supplies sufficient filtered air to support respiration at a much higher efficiency than the PAPRs of prior art, and hence how the present invention can be achieved at much lower costs.

A further benefit of the reservoir is that it acts as a plenum that stores gas at positive pressure. In this way, the positive pressures generated by the fan can be supplemented by positive pressure from the reservoir. This means that a positive pressure can be maintained in the respirator even when the inspiratory flow rate exceeds the fan flow rate.

The respirator system may be configured such that when the user's inspiratory flow rate is less than or equal to the base flow rate of the filter system, filtered air flows from the air filter system to the respirator for inhalation by the user without supplementation from the reservoir.

The respirator and air filter system may be arranged along a first airflow path, and the reservoir and the air filter system are arranged along a second airflow path, such that the air filter system is common to both airflow paths.

The first airflow path may be uni-directional from the air filter system to the respirator, and the second airflow path may be bi-directional from the air filter system to the reservoir and vice versa. The first airflow path may be uni-directional by virtue of a valve arranged along the path.

The air filter system may comprise a junction chamber that is in fluid communication with the reservoir and the respirator, and that is configured to receive the filtered air drawn into the respirator system.

In this way, both the reservoir and respirator are fluidly connected with the junction chamber. Thus, the reservoir is directly connected to the filter system, and indirectly connected to the respirator via the junction chamber. The filter system is directly connected to the reservoir and the respirator. This allows filtered air drawn by the filter system to flow to either the respirator or the reservoir, depending on the inhalation rate of the user, and allows filtered air to flow from the reservoir to the respirator via the junction chamber.

The respirator system may comprise a first conduit arranged to fluidly connect the filter system to the respirator, and a second conduit arranged to fluidly connect the filter system to the reservoir.

The first conduit may connect the air filter system directly to the respirator.

The respirator system may be configured such that when the user's inspiratory flow rate is greater than zero but lower than the base flow rate of the filter system, air drawn into the respirator system by the filter system is directed to both the respirator for inhalation and the reservoir for storage.

The respirator system may be configured such that when a user exhales, air drawn into the respirator system by the filter system may be directed only to the reservoir for storage.

The respirator system may comprise a respirator inlet through which filtered air enters the respirator, and a respirator inlet valve configured to prevent a flow of air through the respirator inlet when the user exhales into the respirator.

The respirator inlet valve may be a non-return valve. The respirator inlet valve may be configured to prevent a flow of air through the valve when the user exhales into the respirator.

The respirator inlet may comprise an opening defined in a body of the respirator. The respirator system may comprise a conduit that fluidly connects the filter system to the respirator. The conduit may meet the respirator at the opening. The inlet valve may be arranged at a junction between the conduit and the opening.

When the respirator inlet comprises an opening in a body of the respirator, the inlet valve may be arranged within or adjacent to the opening.

In such a location, the inlet valve, particularly in the form a non-relief valve, is most responsive to the inhalation and exhalation of the user. Moreover, due to this location, less exhaled breath is able to be stored in the respirator system after exhalation by the user.

The reservoir may comprise an expandable air bag. The reservoir may also comprise a protective covering arranged to extend around, and hence provide protection to, the expandable air bag. The reservoir protective covering may be made from a loose fitting material. The reservoir protective covering may be a rigid container. The reservoir protective covering may be open to the atmosphere.

The respirator system is preferably portable.

The respirator system may comprise a support for securing the respirator to a user's face by extension around the user's head. The respirator may be secured to a forward portion of the support and the filter system may be secured to a rearward portion of the support.

In this arrangement, in use, when the respirator is arranged over a user's mouth, the filter system will be arranged at the back of the user's head. In this location, the filter system does not obstruct the user's view. Furthermore, arranging the filter system at the rear of the head provides balance (i.e. the weight of the filter system at the rear partially offsets the weight of the respirator at the front), increasing comfort.

The support may be a strap.

The first conduit may be incorporated into the support. The second conduit may be arranged to depend downwardly from the filter system when the respirator system is arranged for use, with the reservoir arranged at the bottom of the second conduit.

In this way, when the respirator system is worn for use, the second conduit depends downwardly from the filter system at the back of user's neck, such that the reservoir lies behind the user's back in use. In this position the reservoir can be particularly easily accommodated.

The respirator may be configured to seal around the user's nose and/or mouth area such that an air cavity is defined between the respirator and the user's face for receiving filtered air from the air filter system and/or reservoir.

With this sealing arrangement, air received in the air cavity by the filter system and/or reservoir, may create a positive (i.e. above ambient) pressure in the cavity.

The seal guards against air flow from the atmosphere into the air cavity, thereby maintaining a high protection factor. To provide the seal, a periphery of the respirator is shaped to the typical contours of a face, and the periphery is formed of a flexible material to accommodate the contours precisely. Where it is provided, the support may allow the respirator to be held in position and sealed against the person's face.

The respirator may comprise a respirator outlet through which exhaled air can exit the respirator, and an outlet valve arranged in or adjacent to the respirator outlet, wherein the outlet valve is configured to permit air flow out of the respirator when the user exhales and to prevent air flow into the respirator from the atmosphere.

The outlet may also be provided with a flow regulator, for example in the form of a filter, to regulate the rate of air flow out of the respirator. This can assist in maintaining a positive pressure in the respirator by ensuring that air does not flow too quickly out of the respirator through the valve. Alternatively or additionally the outlet valve can be spring loaded such that air is released therefrom only when the pressure inside the respirator is raised to a sufficient level to offset the inherent spring force of the spring. This prevents leakage from the respirator when the user is not exhaling, thereby maintaining the positive pressure in the respirator. The spring force can be tuned to ensure that the valve will only open on exhalation.

The respirator outlet may comprise an opening in the or a body of the respirator, and the outlet valve may be arranged within or adjacent to the opening. The outlet valve may be a non-return valve.

The respirator comprises a mouth-cover region that is shaped to cover a user's mouth, and the outlet valve is preferably located on the mouth-cover region, and the inlet valve is located remote from the mouth-cover region, such that when the respirator is arranged over a user's mouth, the outlet valve is located in front of the mouth, while the inlet valve is located away from mouth. This allows exhaled breath to be removed more effectively.

The respirator system may comprise a power supply, such as a battery, for powering the air filter system. The air filter system may comprise a fan powered by the power supply.

The respirator system may be for use by medical and/or non-medical personnel. In particular, the respirator system can protect a user from inhaling any pathogens (e.g. viruses) and/or particulates (e.g. pollution and dust) that may be present in the ambient environment. Furthermore, the respirator system may be used in any setting where filtering of the ambient environment is required.

The invention also extends to a method of delivering filtered atmospheric air to a user for respiration, the method comprising: drawing air from the atmosphere into the respirator system at a base flow rate, filtering the drawn air, and delivering drawn filtered air to the user for inhalation. The method further comprise i) when a user inspiration rate is less than the base flow rate, delivering drawn filtered air to a reservoir for storage, and ii) when the user inspiration rate exceeds the base flow rate, supplementing the drawn filtered air delivered to the user with stored filtered air from the reservoir.

The method may be for delivering filtered atmospheric air to medical and/or non-medical personnel. In particular, the method can protect users from inhaling any pathogens (e.g. viruses) and/or particulates (e.g. pollution and dust) that may be present in the ambient environment. Furthermore, the method may be used in any industry where filtering of ambient environment is required.

The invention extends further to a respirator system configured to operate the method described above.

It should be appreciated that features of any one aspect or embodiment of the invention may be used, alone or in appropriate combination, with other aspects and embodiments as appropriate. In particular, the first aspect (including an adjusting means for adjusting a spacing between the two air filter systems to secure the support to the user's head), may be used in combination with any suitable optional or preferred features of the second aspect (including the reservoir). The first and second aspects may be used independently, or in combination.

### BRIEF DESCRIPTION OF THE DRAWINGS

FIG. 1, which is a graph of inspiratory flow rate over time, has already been described above in relation to the prior art. Embodiments of the invention will now be described, by way of example only, with reference to the remainder of the accompanying drawings, in which:

FIG. 2 is a schematic of a respirator system according to a first embodiment of the invention;

FIGS. 3a to 3c are schematics showing the airflow in the respirator of FIG. 2 in different circumstances;

FIG. 4 is a graph showing inspiratory flow rate over time, and volume of a reservoir bag forming part of the respirator system of FIG. 2 over the same time period;

FIG. 5 is a side view of another respirator system incorporating a head support;

FIG. 6 is a comparative graph of the pressure in the respirator during a breathing cycle of the respirator system of FIG. 2, compared to the corresponding pressure in negative pressure respirators of the prior art;

FIG. 7 is a schematic of a respirator system according to another embodiment of the invention;

FIG. 8 is a side view of the respirator system of FIG. 7 incorporating a head support;

FIG. 9 is a back view of a respirator system according to another embodiment of the invention;

FIG. 10 is a comparative graph of the fit factor of the respirator system of FIG. 9 against minute volume, compared to two corresponding respirator systems.

FIG. 11 is a comparative graph of the fit factor of the respirator system of FIG. 9 against peak inspiratory flow rate, compared to two corresponding respirator systems.

FIG. 12 is a comparative graph of the minimum gauge pressure of the respirator of the respirator system of FIG. 9 against peak inspiratory flow rate, compared to the respirator of two corresponding respirator systems.

FIG. 13 is a comparative graph of the fit factor of the respirator system of FIG. 9 against the minimum gauge pressure of the respirator thereof, compared to two corresponding respirator systems.

FIG. 14 comprises two comparative graphs of the respirator (mask) gauge pressure of the respirator system of FIG. 9 at low (above) and high (below) flows, compared to two corresponding respirator systems.

### DETAILED DESCRIPTION OF EMBODIMENTS OF THE INVENTION

The invention relates to a portable respirator system 1 which delivers filtered atmospheric air to a user 100 of the respirator system 1 for inhalation. That is to say, the respirator system 1 can be used in such a way that the user 100 is prevented from breathing any unfiltered atmospheric air. In this way, should the atmospheric air, i.e. the air outside the respirator system 1, contain any harmful particles such as airborne pathogens, pollution or dust, the respirator system will filter out such particles, and deliver only the filtered air to the user 100.

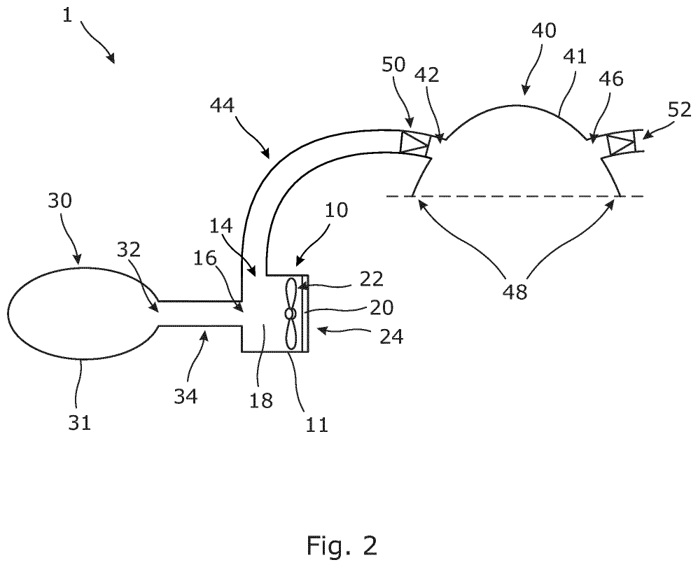

As shown in FIG. 2, the respirator system 1 comprises an air filter system, exemplified here as a fan-filter system 10, for drawing atmospheric air into the respirator system 1 and for filtering all air passing therethrough, a respirator 40 for receiving filtered air and arrangeable to communicate with a user's nose and/or mouth (not shown) so that user 100 can inhale the filtered air received in the respirator 40, and a reservoir 30 for storing filtered air.

To draw and filter the air, the fan-filter system 10 comprises an air drawing means, exemplified here as a fan 22, for drawing the air from the atmosphere (or ambient environment) into the respirator system 1 and a filter medium 20 for filtering the air drawn through the fan 22.

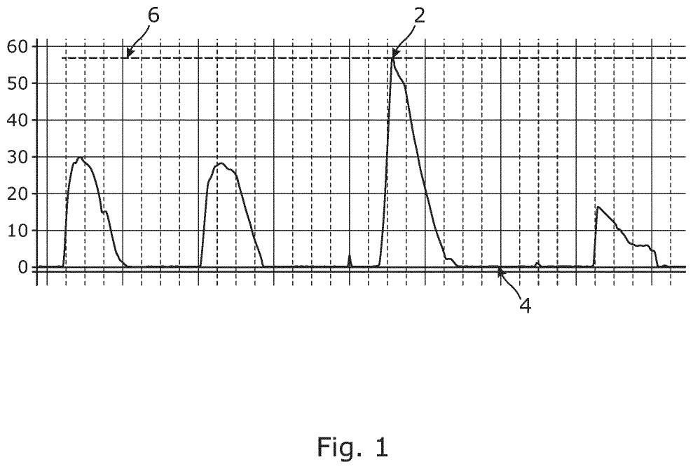

The fan 22 draws air into the respirator system 1 at a base flow rate, while the user 100 inhales air from the respirator 40 at an inspiratory flow rate. As described in the introductory section and shown in FIG. 1, when a user inhales, the inspiratory flow rate is greater than zero, and while the user is exhaling, or neither inhaling nor exhaling, the inspiratory flow rate is zero. The inspiratory flow rate may vary from one inhalation cycle to another, and highest inspiratory flow rate is known as the ‘peak inspiratory flow rate’.

In the respirator system described, the base flow rate of the fan 22 is lower than the peak inspiratory flow rate of the user 100.

In the systems of the prior art, where the base flow rate of the fan is set to be at least equal to the peak inspiratory flow rate of the user 100, the fan 22 is always running at or above the capacity required by the user 100. By contrast, in this system 1, the base flow rate of the fan 22 is sometimes lower than the actual inspiratory flow rate of the user 100, and is sometimes higher than the actual inspiratory flow rate of the user 100.

That is, the fan 22, on its own, does always not deliver sufficient air to the respirator 40 to allow the user 100 to inhale at the desired inspiration rate.

The respirator system 1 can accommodate the low base flow rate of the fan because of the reservoir 30 that stores filtered air from the fan-filter system 10. The respirator system 1 is configured such that when the base flow rate of the fan 22 exceeds the actual inspiratory flow rate, excess filtered air not required by the user is stored in the reservoir 30 for later use. When the user's inspiratory flow rate exceeds the base flow rate of the fan 22, the respirator system 1 is configured such that filtered air stored in the reservoir 30 supplements the air provided by the fan 22, and is drawn into the respirator 40 for inhalation. In this way, the reservoir 30 provides the supplementary filtered air required to allow the user 100 to breathe at an inspiration rate that is greater than the base flow rate of the fan 22. As such, it can be understood that the reservoir 30 allows the fan 22 to work at a lower base flow rate.

Since, by way of the reservoir 30, the fan 22 can operate at a lower base flow rate, the power required to drive the fan 22 is reduced compared to conventional PAPRs. As a result the battery that powers the fan 22 can be smaller, lighter and less expensive and/or can power the fan for a longer period of time.

As such, by including the reservoir component 30, there is the unforeseen technical effect that the respirator system 1 can be lighter, more easily carried and used for longer, and at the same time the cost of the respirator system 1 is substantially reduced.

A further advantage conveyed by the use of the reservoir 30, and hence the lower air flow requirements for the fan 22 associated therewith, is an increased filter life. As filters 24 become clogged with particulates their efficiency decreases. The time it takes for this to happen is a function of the particulate concentration of the surrounding environment (e.g. a filter 24 will clog quicker in a dustier environment) and the volume of gas moved through the filter 24 over time. The much lower air flow requirement allowed for by the reservoir 30 therefore enhances the longevity of the filters 24, potentially by 2 or 3 times.

Of course, the skilled person will appreciate that the inspiratory flow rate of the user 100, and hence its peak, varies in dependence on the user 100 (since humans breathe at different inspiratory flow rates). For the purposes of this application therefore, the peak inspiratory flow rate of the user 100 is therefore defined as the typical peak inspiratory flow rate of an adult man. Likewise, the skilled person will appreciate that the inspiratory flow rate of the user 100 also depends on the extent to which the user 100 is exerting themselves (i.e. whether they are resting or working). The peak inspiratory flow rate of the user 100 for these purposes is therefore defined as the typical peak inspiratory flow rate of a man while resting, i.e. approximately 60 L/min, and the typical peak inspiratory flow rate of a man during light work, i.e. approximately 100-125 L/min. Other relevant values are easily sourced by the skilled person.

Considering the structure of the respirator in more detail, and referring still to FIG. 2, the respirator system 1 comprises the fan-filter system 10, the reservoir 30 and the respirator 40. The fan filter system 10 is in fluid communication with the respirator 40 via one or more first conduits 44. The fan filter system 10 is also in fluid communication with the reservoir 30 via a second conduit 34.

In this way, the fan-filter system 10 is separately and directly connected to each of the reservoir 30 and to the respirator 40. The reservoir 30 is directly connected to the fan-filter system 10, and only indirectly connected to the respirator 40 via the fan-filter system 10 (and vice versa).

The reservoir 30, the fan filter system 10 and the respirator 40 are thereby arranged along two parallel airflow paths: a first airflow path from the filter system 10 to the respirator 40 and a second airflow path from the filter system 10 to the reservoir 30. The airflow path from the filter system 10 to the respirator 40 is uni-directional, such that air flows only from the filter system 10 to the respirator 40, while the airflow path to the reservoir 30 is bi-directional, such that air flows both from the filter system 10 to the reservoir 30 and from the reservoir 30 to the filter system 10.

This allows filtered air drawn by the fan-filter system 10 to flow to the respirator 40 and/or the reservoir 30, in dependence on the inspiration rate of the user 100, and allows filtered air to flow from the reservoir 30 to the respirator 40 via the junction chamber 18, also in dependence on the inspiration rate of the user 100 (as will be explained in detail later on).

Considering the fan-filter system 10 in more detail, to house the fan 22 and filter 20, the fan-filter system comprises a body in the form of an enclosed housing 11, having an internal housing cavity that defines a junction chamber 18. The body of the housing may be made from any suitable material, such as for example metal, wood, a plastics material or an elastomeric material.

The body of the housing 11 is provided with various openings that open into the junction chamber 18. A first opening is an air inlet 24, through which atmospheric air is drawn into the fan-filter system 10 via the fan and filter. A second opening is a respirator opening 14 that communicates with the first conduit 44, and hence with the respirator 40. A third opening is a reservoir opening 16 that communicates with the second conduit 34 and hence with the reservoir 30. Each of the first, second and third openings may comprise multiple apertures or sub-openings, so as to improve air flow into the housing 11.

In this example, the air inlet 24 is preferably located on a first side of the housing 11, while the reservoir opening 14 and respirator opening 16 are located on different sides of the housing 11.

The filter 20 is arranged in the fan-filter housing 11 and is configured to prevent unwanted airborne particles from entering the internal housing cavity. To this end, the filter 20 is arranged to extend across the air opening 20. In this way, no air can enter the junction chamber 18 without first passing through the filter 20. In one preferred embodiment, the filter 20 comprises a P100 filter.

The filter 20 provides a suitably large resistance to flow such that when the user's inspiratory flow rate exceeds the base flow rate of the fan 22, air is drawn from the reservoir 30 into the respirator 40 for respiration and not from the atmosphere and through the fan-filter system 10 into the respirator 40. The skilled person appreciates that in the exceptional circumstance that i) the user's inspiratory flow rate exceeds the base flow rate of the fan 22 and ii) insufficient air is contained within the reservoir 30 for inhalation, additional air will be drawn in from the ambient environment through the fan-filter system 10 and into the respirator 40 for inhalation, as a result of the additional pressure created by the high inspiratory rate of the user 100.

The filter may be configured for particular situations and environments. For example, the filter may be configured for use in an environment having a high particulate content in the air, and may be configured to filter particulate matter: for example, the filter may be a PM2.5 filter or a PM10 filter. The filter may be easily accessible so that the filter can be quickly and easily replaced by the user.

The fan 22 is configured to draw air from the atmosphere into the internal housing cavity through the filter 20, and into the respirator 40 and/or reservoir 30. Aside from the pressure differential in the respirator 40 caused by the user's inhalation, only the fan 22 is used to move air through the respirator system 1. The fan 22 is arranged within the internal housing cavity, preferably in or adjacent to the air inlet 24.

The base flow rate of the fan 22 may be constant for any given operational mode, although fans with variable base flow rates can be used also. If the base flow rate of the fan 22 varies during a single operational mode, the base flow rate is taken to be an average value of the fan's variable base flow rate.

To control a fan 22 with a variable base flow rate, the respirator system 1 may be provided with a control system (not shown) configured to measure the pressure within the air reservoir 30 and to adjust speed of the fan 22 of the fan-filter system 10 in accordance with the measured pressure, so as to optimise the delivery of filtered air to the user 100. To this end, such a control system can be provided with a differential pressure sensor (not shown) embedded within the reservoir 30 and configured to measure the pressure within the air reservoir 30, and a microcontroller coupled to the differential pressure sensor and to the fan 22 and configured to adjust speed of the fan 22 of the fan-filter system 10 in accordance with the measured pressure.

As part of a slower feedback mechanism, the control system can be operable to adjust the base flow rate of the fan 22 to accommodate different breathing rates/depths of different users. For example, the breathing demands of a small adult woman will be less than those of a large adult man such that a lower fan speed could supply sufficient airflow and pressure within the reservoir for the small adult woman but not the large adult man.

Similarly, and as detailed above, the breathing demands placed on the respirator system 1 will be different if the wearer is at rest than when performing tasks.

Contemporaneously, and as part of a more rapid feedback mechanism, the control system can be operable to the base flow rate of the fan 22 in response to breath-by-breath changes within pressure within the air reservoir 30. This is achieved by the control system operating to maintain the pressure within the reservoir 30 at a predetermined level. When said pressure drops below this level during exhalation, the inhalation valves are closed and the flow from the fan 22 is directed to the reservoir 30. The pressure in the reservoir 30 will rise and as it nears the target level the fan speed will slow down. When the user 100 inhales the pressure in the air reservoir 30 will fall and control system will speed the fan up to achieve the target level.

These two feedback mechanisms may be co-dependent; for example, it would be advantageous for the gain of the second control loop to be increased if the baseline fan speed is low, while the gain available, in any case, will be attenuated at high baseline fan speeds.

Alternatively or additionally, the fan 22 may be configured for adjustment by the user 100 to work at different base flow rates in different operational modes. For example, one mode may be a resting mode with a lower base flow rate and one mode may be a moderate intensity work mode with a higher base flow rate. In this case, the fan-filter system 10 is provided with a user input (not shown) where the user 100 can change the operational mode. In one preferred embodiment, the user input takes the form of a selection of buttons arranged on the respirator system 1.

Regardless of whether the base flow rate varies or not, the (average value of the) base flow rate of the fan 22 is selected to be less than half of the user's peak inspiratory flow rate and in some embodiments less than a third of the user's peak inspiratory flow rate. For example, the base flow rate of the fan may be between approximately 15 and 35 L/min, and preferably approximately 30 L/min for a resting mode, and between approximately 40 and 70 L/min, and preferably approximately 60 L/min for moderate intensity work.

In further embodiments, a fan 22 with an even lower base flow rate may be used. Such a fan 22 may be configurable to operate at both the base flow rate and an elevated base rate during any particular operational mode. In this way, if, during inhalation, the user's inspiratory flow rate exceeds the base flow rate of the fan 22 and insufficient air is contained within the reservoir 30, the fan may be selected to operate at the elevated base rate. Thereafter, the fan 22 then operates at the base flow rate again. The elevated base rate may be selected for use in dependence on a user selection at the user input or even in dependence on a reservoir sensor sensing automatically that the reservoir is empty.

In one preferred embodiment, the fan 22 comprises a single (Delta Electronics) 5V blower (50×10 mm). This embodiment is particularly suitable for use during resting and low work intensity tasks. In another embodiment, the respirator may be provided with two such fans. This embodiment is more appropriate for moderate work intensity tasks. For other uses requiring a higher flow rate, a combination of larger fans, or an additional fan exclusively designated to fill the reservoir, can be used.

To power the fan 22, the control system and/or other electrical systems of the respirator system 1, the respirator system 1 is provided with a power supply 13 such as a battery. Such a power supply 13 may be accommodated within the fan-filter system. However, in a preferred embodiment, the power supply 13 is separate to, i.e. enclosed in a separate housing to, the housing 11 of the fan-filter system 10. This advantageously provides a modular arrangement that allows each of the fan-filter system 10 and the power supply 13 to be handled (and e.g. repaired) separately.

The battery may be any suitable battery that is capable of powering the fan and the other electrical systems on the respirator system 1. For example, the battery may supply a voltage of 5V. The battery may preferably be a thin flexible battery, for example a battery of the type described in EP2534713B or WO2017-207735, or a standard pouch/cylindrical cell. The battery may be in the form of a battery pack comprising at least one single-use or rechargeable cell, preferably in the form of a standard lithium cell.

The power supply 13 is preferably provided with voltage regulation circuity (not shown) to regulate the voltage thereof, a battery charge monitoring system (not shown) configured to measure the charge thereof, a charge-indicating display (not shown) configured to display the measured charge thereof and/or a low-battery audible alarm (not shown) configured to provide a signal to the user via a user output (not shown) when the measured charge of the battery drops below a predetermined charge threshold. In one preferred embodiment, the user output takes the form of an audible alarm such as beeps or a light and provides signals in the form of an audible alarm signal or a flashing light signal respectively.

The power supply 13 may be removably insertable in the respirator system 1, thereby allowing the power supply 13 to be replaced during use. Additionally or alternatively, the power supply 13 may be chargeable by way of a portable power pack or by way of a mains supply. To this end, the power supply 13 may be provided with a port that can be connected to such a power pack or mains supply by way of a tethered connection.

Turning to the reservoir 30, the reservoir 30 is configured to store filtered air. To this end, the reservoir 30 takes the form of an expandable air bag comprising an expandable body 31 defining a variable internal volume. The reservoir 30 is made out of a flexible material such as a polymer. The maximum volume of the reservoir 30 is preferably approximately 0.5 to 2 litres, but may be larger in some embodiments. The reservoir 30 may be any suitable shape, though a generally elongate shape is preferred, having a length greater than its width.

The reservoir 30 may also comprise a protective covering (not shown) arranged to extend around, and hence provide protection to, the expandable air bag. The reservoir protective covering may be made from a loose fitting material. The reservoir protective covering may also be a rigid container. The reservoir protective covering may be open to the atmosphere.

The reservoir 30 can be adapted in size and/or shape not only for ergonomic reasons, but so that the respiratory system 1 may better accommodate a user's particular breathing pattern (in relation to both flow rates and/or depths). Such adaptation has not been possible for prior PAPR designs where reservoirs were not included.

The reservoir 30 further comprises a reservoir opening 32 defined in the body 31 of the reservoir 30 that serves as both an inlet to and outlet from the reservoir 30. The second conduit 34 meets the reservoir 30 at the reservoir opening 32.

The respirator 40, or mask, comprises a respirator body 41 that is arrangeable to cover the user's nose and/or mouth (not shown). The respirator body 41 generally defines a dome shape.

A periphery 48 of the respirator body 41 is shaped such that it may be arranged to lie in contact with the user's face 101b around the user's nose and/or mouth. In other words, the periphery 48 of the respirator body 41 is shaped to the typical contours of a face 101b. The periphery and may also be formed of a flexible material to accommodate the contours precisely. As a result, the respirator body 41 can seal against the user's face 101b when worn. This seal can restrict against air flow from the atmosphere into the air cavity, thereby maintaining a high protection factor. Preferably, the respirator 40 seals around the user's nose and/or mouth.

The respirator 40 further comprises a respirator inlet 42 through which filtered air from the fan-filter system 10 and reservoir 30 enters the respirator 40 and a respirator outlet 46 through which user exhaled air exists the respirator 40, and hence the respirator system 1. The respirator inlet 42 and outlet 46 each include an opening defined in the respirator body 41.

The first conduit 44 meets the respirator 40 at the respirator inlet 42 to connect the fan-filter system 10 directly to the respirator 40. A respirator inlet valve 50 is arranged at or adjacent to the respirator inlet 42, i.e. at a junction between the first conduit 44 and the inlet 42. The respirator inlet valve 50 preferably takes the form of a non-return valve. The inlet valve 50 is configured to prevent a flow of air out of the respirator through the respirator inlet 42 whenever the user 100 exhales, and to permit a flow of filtered air through the respirator inlet 42 into the respirator 40 whenever the user 100 is not exhaling into the respirator 40, (i.e. when the user 100 is inhaling or when the user 100 is neither inhaling nor exhaling).

This inlet valve 50 therefore advantageously prevents any exhaled air from being drawn back out of the respirator 40 into the reservoir 30 or fan-filter system 10, and assists in ensuring all exhaled air is expelled through the respirator outlet 46.

The position of the respirator inlet valve 50 at a junction between the first conduit 44 and the inlet 42 means that the valve 50 is as close as possible to the respirator 40. In this location, the inlet valve 50 is most responsive to the user's breathing. Moreover, this location minimises the amount of exhaled breath that is storable in the respirator system 1 for re-inhalation by the user 100.

The respirator outlet opening is preferably arranged in a mouth-cover region of the respirator body, i.e. the region of the respirator body 41 which, when the respirator 40 is arranged over the user's face 101b, lies opposite the user's mouth (not shown). Meanwhile, the respirator inlet opening is preferably arranged away from the respirator outlet opening. This arrangement allows the exhaled breath to be removed more effectively.

The respirator outlet 46 comprises a respirator outlet valve 52 arranged in or adjacent to the respirator outlet 46. The outlet valve 52 is configured to permit air flow out of the respirator 40 when the user 100 exhales into the respirator 40 and to prevent any air flow from the atmosphere directly into the respirator 40. This therefore prevents any unfiltered atmospheric air from being drawn into the respirator 40 through the respirator outlet 46, which would otherwise compromise the protection factor of the respirator system, while at the same time allowing exhaled air to be expelled from the respirator 40 as the user 100 breathes out, thereby preventing a build-up of CO₂ in the respirator 40. To this end, the respirator outlet valve 52 preferably takes the form of a non-return valve that may be spring loaded to prevent the valve 52 from opening purely as a result of the low level of positive pressure that is generated by the fan. In this way, the spring-loaded non-return valve assists in sustaining a positive pressure in the respirator 40.

The respirator outlet 46 may further comprise a flow regulator (not shown), for example in the form of a filter, to regulate the rate of air flow out of the respirator 40. This can assist in maintaining a positive (i.e. above ambient) pressure in the respirator 40 (in addition to or instead of a spring-loaded non-return valve) by ensuring that air does not flow too quickly out of the respirator 40 through the respirator outlet valve 52.

The spring-loaded non-return valve and/or flow regulator filter prevent filtered air from exiting the respirator 40 when the user 100 is not exhaling, thereby ensuring filtered air is directed to the reservoir 30 for storage instead.

When the respirator 40 is arranged to fit around the user's nose and/or mouth area (not shown), an air cavity is formed between the respirator 40 and the user's face 101b. Due to the operation of the fan 22 and/or reservoir 30 in combination with the respirator 40, a positive (i.e. above ambient) pressure is maintained within this air cavity. Such an arrangement is advantageous if the respirator 40 does not form a perfect seal around the user/s mouth and/or nose. Due to the positive pressure in the respirator 40, filtered air is pushed out of the respirator through any openings, and this outward flow of air guards against atmospheric air from outside the respirator 40 entering the respirator, thereby preventing the user 100 from inhaling potentially harmful particles in the atmosphere.

As a result of this arrangement, the respirator 40 need not be arranged so tightly on the user 100, since the consequence of a break in the seal should not result in any harmful particles entering air cavity. As such, the respirator 40 is more comfortable to wear and can be used with ease for longer periods of time.

The respirator 40 may take the form of a standard commercially available negative pressure respirator that has been adapted with an adaptor in the form of an expiratory filter and/or loaded respirator outlet valve 52 at the outlet thereof. In this way the negative pressure respirator can be used to produce a positive pressure therewithin. The respirator 40 may likewise take the form of a bespoke mask designed to maintain a low level of positive pressure therewithin.

More detail about the control system will now be provided, and in particular the assessments that the control system can undertake.

Firstly, the control system is operable to assess the adequacy of the respirator-to-face seal—that is, the adequacy of the sealing of the respirator 40 around the user's face 101b.

To begin, the respirator system 1 is first arranged on and secured to the user's head 101a. The user 100 then provides an input to the respirator system 1 via the user input to begin said assessment. Thereafter, the respirator system 1 indicates to the user 100 to hold their breath using the user output.

Thereafter, and while the user 100 is holding their breath, the control system causes the fan 22 to operate at a maximum flow rate again and then immediately causes the fan 22 to stop operating for a short period. At the same time, the control system is also monitoring the pressure within the air reservoir 30. Thereafter, the respirator system 1 indicates to the user 100 to stop holding their breath and to return to normal breathing.

The skilled person will appreciate that a perfect respirator-to-face seal would result in no change in pressure in the reservoir 30 during the period when the user 100 was holding their breath. If the seal was not perfect, a drop in pressure in the air reservoir 1 would instead be detected during this time. The skilled person will further appreciate that the extent to which the pressure drops is proportional to the leakage—the greater the rate of change in pressure over time the larger the leak.

Based on the control system's assessment, the respirator system 1 will inform the user 100 using the user output whether the respirator fit was acceptable, i.e. whether the drop in pressure within the reservoir 30 during the breath-hold period was less than a pre-determined threshold, or not. If not, the user 100 can adjust the respirator fit and repeat the assessment.

Secondly, the control system is operable to assess whether the fan-filter system 10 is providing sufficient filtered air flow. This is useful as the filter 20 can become clogged during use, such that a pressure drop is caused across the filter 20, and the flow of filtered air is reduced.

To assess whether the fan-filter system 10 is establishing a sufficient flow, the respirator system 10 is first arranged on, and secured to, the user's head 101a and the respirator system 1, i.e. the fan 22, is turned on. The user 100 then provides an input via the user input to begin said assessment.

Thereafter, the fan 22 is switched off, allowing the air reservoir 30 to become deflated. When the appropriate base pressure is reached in the air reservoir 30, the respirator system 1 signals to the user 100 by way of the user output to hold their breath. The user 100 then places the palm of their hand over the respirator outlet valve 52 so as to block it entirely. The fan 22 is then switched back on so that the pressure in the reservoir 30 rises over time until a peak pressure is reached.

The control system then computes the flow rate based on (i) the time recorded to reach a particular pressure and (ii) the pressure-volume characteristics of the reservoir 30. For example if it is known that the bag reaches a pressure of 1 mmHg when filled with 1 litre of gas and it takes 2 seconds to reach this pressure then the flow rate is 0.5 l/s or 30 l/min.

An advantage of such a method is that it can be done with the respirator system 1 being worn. Furthermore, the measurement is empirical and hence takes into account real-world and real-time factors that affect the flow available to the user 100: for example, the leakage of air by the respirator. Any flow of filtered air that is lost from the respirator-to-face seal will not reach the reservoir 30 and will not be available for use: the measurement does not include this flow so automatically excludes it. This is in contrast to other systems which measure the flow rate at source and an implicit assumption is made that all this flow is made available to the wearer.

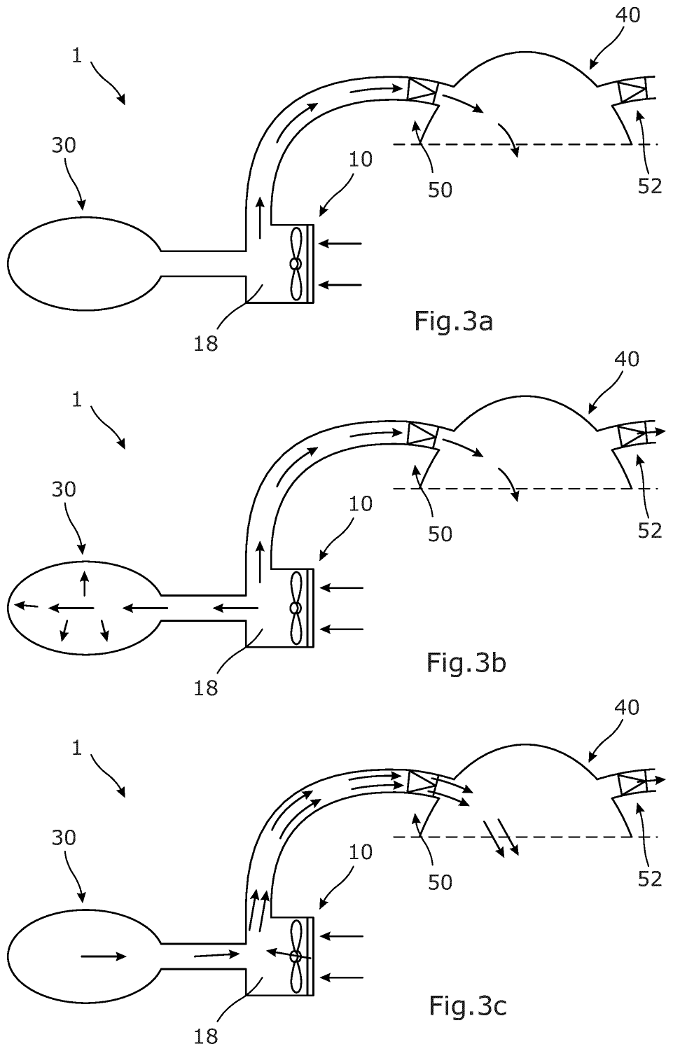

The flow of air around the respirator system 1 when the respirator system 1 is in use will now be described with reference to FIGS. 3a to 3c.

In all circumstances (FIGS. 3a to 3c), atmospheric air is drawn into the fan-filter system 10 by the fan 22 from outside the respirator 40 at the base flow rate. In particular, air is drawn through the filter 20 and into the junction chamber 18.

Where this filtered air then travels next depends on whether the user 100 is exhaling, or inhaling, and the user's inspiratory flow rate.

FIG. 3a shows the airflow when the user 100 is inhaling with an inspiratory flow rate that is equal to the base flow rate. In this case, filtered air in the junction chamber 18 is drawn through the first conduit 44 to the respirator 40 for inhalation by the user 100. Because the user's inspiratory flow rate matches the base flow rate, all filtered air in the junction chamber 18 is drawn to the respirator 40 for inhalation.

FIG. 3b shows the airflow when the user 100 exhales. Exhalation causes the respirator inlet valve 50 to close, so that filtered air in the junction chamber 18 or first conduit 44 is prevented from entering the respirator 40. With this route closed, all the filtered air drawn into the junction chamber 18 is drawn into the reservoir 30 for storage. Meanwhile, in the respirator 40, exhaled air exits the respirator through the respirator outlet valve 52.

While the inlet valve 50 is closed, some air pressure may also build up behind the inlet valve 50 as the user exhales. When exhalation stops, the inlet valve 50 can open, relieving the air pressure and pushing air into the respirator 40.

FIG. 3c shows the airflow when the user's inspiratory flow rate exceeds the base flow rate. This is expected to be the situation for most inhalations by the user, since the base flow rate of the fan is selected to be significantly below the peak inspiratory rate. In this case, since the airflow from the fan is insufficient to match the inspiratory of the user, the user's inhalation creates a pressure differential that draws filtered air stored in the reservoir 30 into the respirator via the junction chamber 18. In this way, the air from the reservoir supplements the air that is drawn directly from the fan filter system 10, to meet the user's inspiratory requirement while supporting the maintenance of positive pressure in the respirator 40 even when the breathing demand exceeds the flow rate capability of the fan 22.

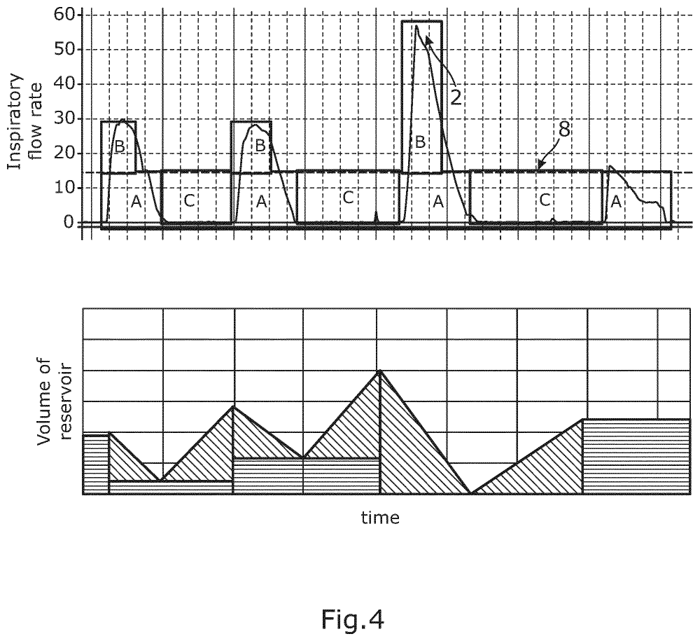

FIG. 4 is a graph showing the user's inspiratory flow rate over time, with a peak inspiratory flow rate indicated at 2, and the base flow rate of the fan indicated at 8. Also shown is the volume of the reservoir bag over the same time period.

As can be clearly seen in FIG. 4, when a user inhales at a rate above the inspiratory flow rate, part of the air for inhalation is provide by the fan (block A), and part is provided by the reservoir (block B). During this time, the volume in the reservoir decreases. When the user's inspiratory flow rate drops below the base flow rate 8 of the fan, air is supplied to the reservoir 30 (block C), and the volume of the reservoir increases. If the user's inspiratory flow rate matches the base flow rate of the fan, the volume of air in the reservoir remains substantially constant.

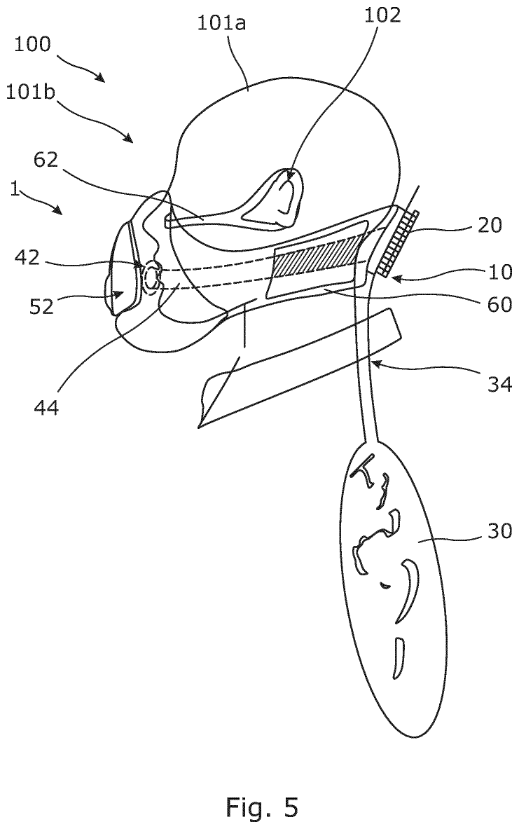

As shown in FIG. 5, the respirator system 1 is portable, and is securable to a user 100 in such a way that it can be used handsfree, thereby allowing the user 100 to use their hands for other purposes.

To maintain the respirator 40 in place on the user's face 101b, the respirator system 1 is provided with a support 60, preferably in the form of a strap or harness arrangement, for securing the respirator 40 to a user's face 101b by extension around the user's head 101a below the user's ears 102. The support is preferably made of an elastic material, e.g. neoprene In another embodiment, the strap arrangement may extend around the top of the user's head 101a above the user's ears 10, thereby improving the comfort and fit of the respirator 40 on the user's face 101b.

The fan-filter system 10 is arranged on the support 60. When the power supply 13 is enclosed in a separate housing to the fan-filter system 10, the power supply 13 may also be arranged on the support 60. In this embodiment, the fan-filter system 10 is connected to the power supply 13 via cables woven into the support 60. The fan-filter system 10 and/or power supply 13 may also be connected to the control system via cables woven into the support 60.

An example arrangement is shown in FIG. 5, which shows the system of FIG. 2 when incorporated into a wearable respirator arrangement. In this arrangement, the support additionally comprises head supports 62 in the form of ear supports.

The respirator 40 is secured to a forward, or front, portion of the support 60, such that when the support 60 is arranged around a user's head 101a the respirator 40 is arrangeable to communicate with the user's mouth and/or nose (not shown).

The fan-filter system 10 and its power supply 13 are secured to a rearward portion of the support 60. Securing the fan-filter system 10 and power supply 13 to a support 60 that is worn on the head, rather than a support worn elsewhere on the body, is feasible in this system due to the reduction in size and weight of the power supply 13.

In this arrangement, when the support 60 is arranged around a user's head 101a, the fan-filter system 10 and its power supplyl3 can be supported at the back of the user's head 101a. In this arrangement, neither the fan-filter system 10 nor the power supply 13 is able to obstruct the user's field of view or the user's actions, when the respirator system 1 is worn. Arranging the respirator 40 at the front of the head and the fan-filter system 10 at the rear of the head provides a balanced weight, which is more comfortable for the user. At least some parts of the fan-filter system housing 11 may be made of an elastomeric material such that is conformable to and hence arrangeable on the back of the user's neck.

The first conduit 44 may be incorporated into the support 60 such that, in use, when the support 60 is arranged around the user's head 101a, the first conduit 44 extends around the user's head 101a between the respirator 40 towards the front of the user's head 101a and the fan-filter system 10 towards the rear of the user's head 101a. The conduit may be incorporated into the support by attachment to the interior of the support 60, or it may be integrally formed in the support 60. Alternatively, the first conduit 44 is not incorporated into the support 60 and instead extends between the fan-filter system 10 and the respirator 40.

Meanwhile, the second conduit 34 is arranged to depend downwardly from the fan-filter system 10 when the respirator system 1 is arranged for use, with the reservoir 30 arranged at the bottom of the second conduit 34. Again, in this arrangement, the first conduit 44, the second conduit 34 and the reservoir 30 are all arranged away from the front of the users face, so that they do not obscure the user's field-of-view or actions when the respirator system 1 is in use. In some embodiments, particularly where the reservoir 30 is large, the reservoir is preferably contained within a small container securable either to the user's back (e.g. as a back-pack) or to the user's chest (e.g. as a chest vest). Smaller volume reservoirs 30 are instead suitable for mounting to the back of the user's head 101a and/or neck.

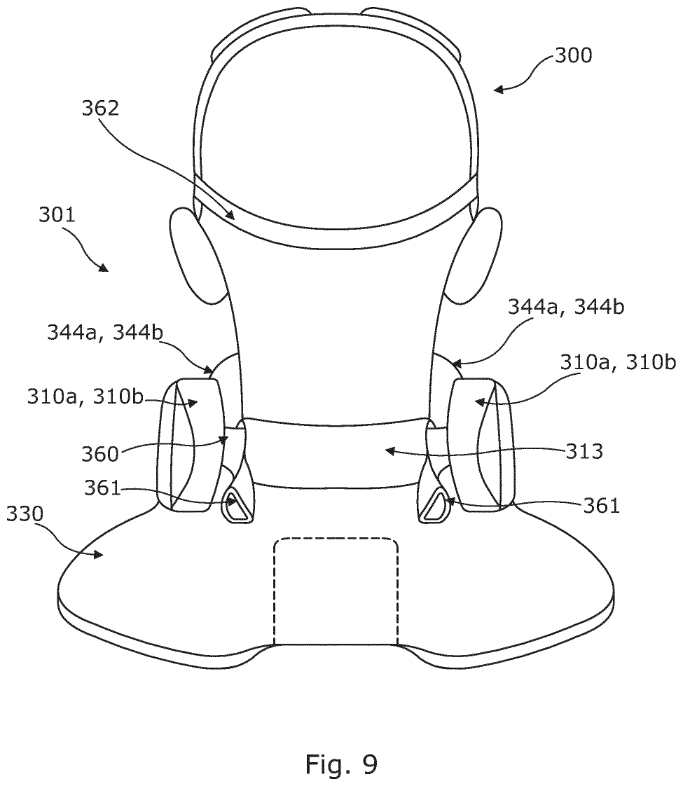

In one embodiment, the reservoir extends over the top of the user's head 101a, and can optionally be secured to the support 60 (see for example FIG. 9). In this embodiment, the second conduit 34 is arranged to extend upwardly from the fan-filter system 10.

To secure the respirator in place on the user's face 101b, the support 60 may be provided with an adjusting means 61 arranged at a rearward portion of the support 60 at the rear of the user's neck configured to shorten the length of the support, and hence secure the respirator system 1 against the user's head 101a, when operated by a user 100. The adjusting means 61 may take the form of tightening straps or a buckle.

When the adjusting means 61 is configured to provide a long support, e.g. when the tightening straps are slack/the buckle is undone, the support can be extended over the user's head 101a so as to arrange the respirator system 1 in place on the user's head 101a. The head support can be placed in position e.g. around the ears at this point. Thereafter, the adjusting means 61 can be adjusted so as to reduce the length of the support so that the respirator system 1 is arranged securely on the user' head 101a.

In an alternate arrangement, the fan-filter system 10 (and power supply 13 if separate) is provided with a channel, typically in the form of series of loops. In this arrangement, the support is fed through said channel around the user' head 101a so as to hold the respirator system in place on the user' head 101a. The reservoir 30 may be provided with fastening means, such as at least two loops with snap fit fasteners, configured to fasten the reservoir 30 to the fan-filter system 10 and/or the power supply 13 and/or the support 60. The respirator 30 is also fastened to the support 60. This arrangement is advantageous as the support 60 can be a standard commercially available harness used for existing respirator systems.

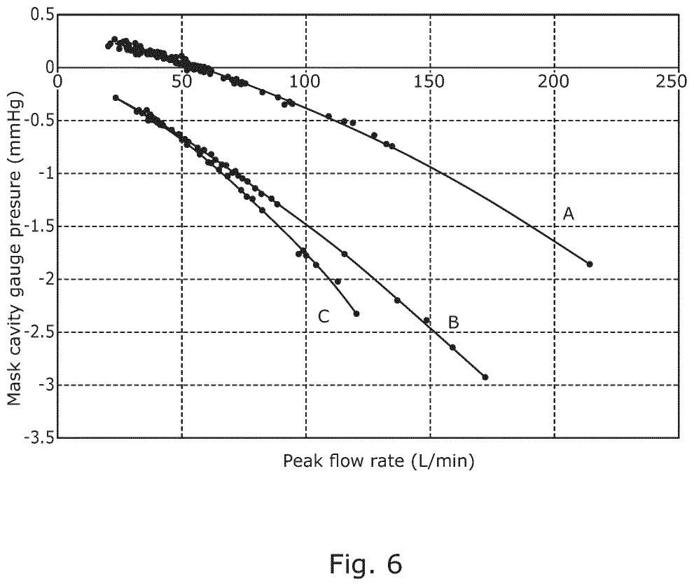

FIG. 6 is a comparative graph of the pressure drop in the respirator 30 as a function of the peak flow rate (data set A), compared to the corresponding pressure drop in a negative pressure respirator of the prior art (data sets B and C). As can be clearly seen, at all peak flow rates, the pressure drop in the respirator of the system described above is significantly lower (approximately 190% lower) than the corresponding pressure in the respirators of the prior art. A large pressure drop indicates a high resistance to breathing, and the larger the drop in pressure, the higher the resistance. Breathing resistance affects user comfort, so the lower the pressure drop the more comfortable the respirator. Moreover, larger pressure drops to more negative pressures increase the likelihood of leakage of unfiltered air into the respirator 30.

It should be noted that the negative pressure respirators of the prior art will not achieve a zero or positive pressure for any peak flow rate. By contrast the respirator described above will achieve zero pressure at a moderate peak flow rate: in this case approximately 55 L/min. The peak flow rate at which zero pressure is achieved can be tuned by tuning properties of the respirator, in particular the base flow rate of the fan.

Variations on the respirator system 1 described above will also be apparent to the skilled person that do not depart from the scope of the appended claims.

For example, the skilled person appreciates that other configurations of the fan-filter system 10 are possible. For example, the fan 22, the filter 20 and the junction chamber 18 need not necessarily be arranged in the same housing 11 and may instead be located in separate housings. The filter 20 may be arranged behind the fan 22.

Furthermore, it will be appreciated that the inlet valve 50 could be arranged anywhere in the first conduit 44, i.e. away from the respirator 40.

Additionally, it can be preferable to arrange two separate first conduits 44 between the fan-filter system 10 and the respirator 40. In this way, an increase in the flow of filtered air between the fan-filter system 10 and the respirator 40 can be achieved, without the use of a bulky single conduit.

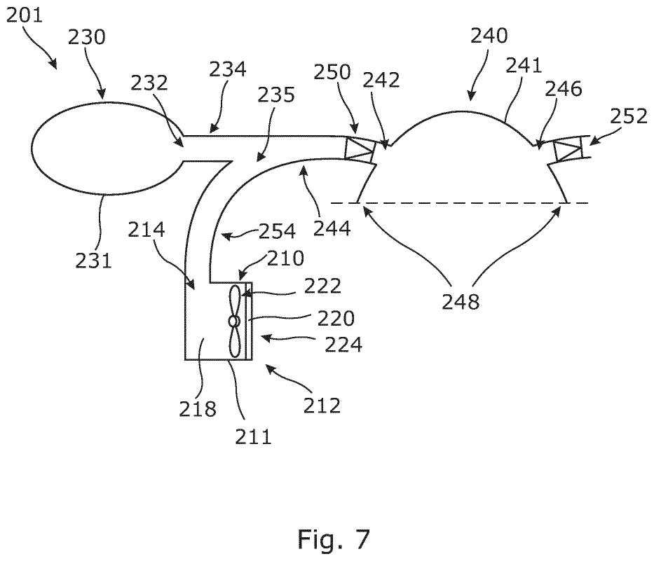

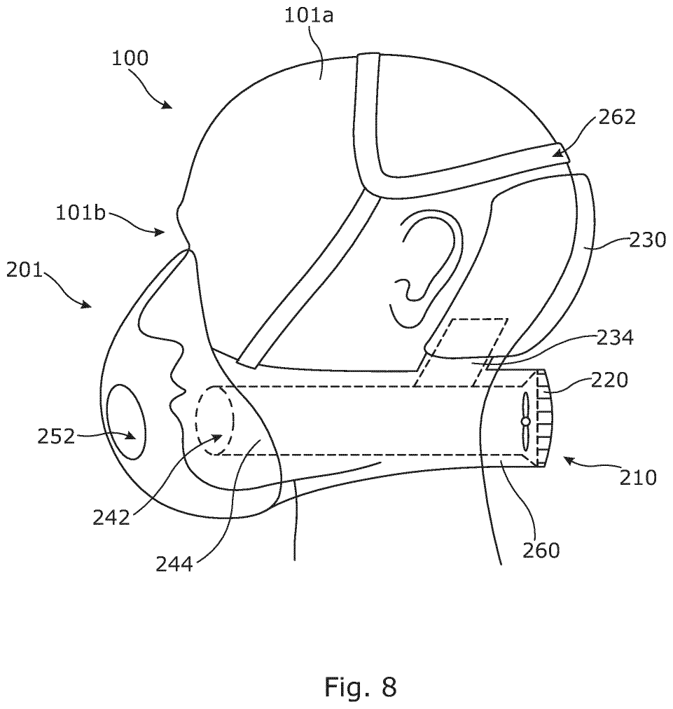

FIGS. 7 and 8 show an embodiment which is substantially the same as the embodiment described above, except for the arrangement of the second conduit 234 that directs air to the reservoir 230.

In this embodiment, the junction chamber of the fan-filter system 210 takes the form of a manifold 235. The manifold 235 is connected to the fan by a third conduit, so that filtered air is directed along the third conduit to the manifold 235.

The second conduit 234 is connected at one end to the manifold 235 and at its other end to the reservoir 230 at the reservoir opening 232, as shown in FIG. 7. The second conduit is therefore arranged to direct filtered drawn air from the fan and the manifold to the reservoir, and to direct stored filtered air from the reservoir to the manifold.

The first conduit is connected at one end to the manifold 235 and to the other end to the respirator 240. The first conduit 244 is configured to provide filtered air from manifold 235 to the respirator 240: this includes air that has reached the manifold from the reservoir 230 (via the second conduit 234), and/or air that has reached the manifold via the fan-filter system 210 (via the third conduit).

In this way, the first conduit 244 provides a uni-directional first airflow path from the manifold to the respirator, and the second conduit 234 provides a bi-directional second airflow path from the manifold to the reservoir and vice versa. The third conduit 244 also provides a uni-directional third airflow path from the air filter system 210 to the manifold 235.

The second conduit 234 is preferably arranged at an acute angle with respect to the third conduit 244 i.e. the second conduit meets the manifold at an acute angle. In other words, the air must at least partially back-flow into the second conduit 234, against the direction of flow of the first conduit 244, to enter the reservoir 230. This acute angle ensures that when the user's inspiratory flow rate is lower than the base flow rate, air will flow to the respirator 240 in preference to the reservoir 230, meaning that there is no requirement to fill the reservoir 230 before air will flow to the respirator 240. When the user's inspiratory flow rate exceeds the base flow rate, the air stored in the reservoir 230 is efficiently delivered to the respirator 240 for inhalation.

In these embodiments, the body of the fan-filter system 210 comprises only a first opening in the form of the air inlet 224, and a second opening in the form of the respirator opening 214 that leads to the third conduit. In other words, the body of the fan-filter system 210 does not comprise a third opening for direct connection with the reservoir 230.

However, it should be noted that in all embodiments, each of the first and second openings may comprise multiple apertures or sub-openings, so as to improve air flow into the housing 211.

Additionally or alternatively, the fan-filter system 210, the reservoir 220, the power supply 213 and/or the control system may be arranged away from the user's head 101a and/or the support 260. In one preferred embodiment, the fan-filter system 210, the reservoir 220, the power supply 213 and/or the power supply 213 are incorporated into a vest or a shoulder mounted harness arrangeable to be worn over the user's torso and/or the top of the user's back, and preferably over any clothes that the user 100 may be wearing.

FIG. 9 illustrates an embodiment in which the respirator system 301 comprises two separately housed fan-filter systems 310a, 310b, each operating independently from the other, and each configured to draw atmospheric air into the respirator system 301 and to filter all air passing through each respective system 310a, 310b. To this end, the fan-filter systems 310a, 310b each comprise an air drawing means exemplified as a fan 322a, 322b and a filter medium 320a, 320b as described above. The two fan-filter systems 310a, 310b are arranged at the rear side of the head 101a on each side of the user's neck.

In this embodiment, each of the fan filter systems 310a, 310b are separately connected to both the respirator 340 and to the reservoir 330. To this end, the respirator system 301 has two first conduits 344a, 344b and two second conduits(not visible in FIG. 9). Each first conduit 344a, 344b directly connects one of the fan filter systems 310a, 310b to the respirator 340. Each second conduit 334a, 334b either directly connects one of the fan filter systems 310a, 310b to the reservoir 330 as per the arrangement of FIG. 2 or feeds into a respective first conduit 344a, 344b as per the arrangement of FIG. 7.

Each of the fan-filter systems 310a, 310b is therefore separately connected to the reservoir 330 and to the respirator 340. In this way, this respirator system 301 has two separate airflow circuits, each comprising a fan-filter system 310a, 310b, and a first and a second conduit 344a, 344b. However, each airflow path is connected to, and in fluid communication with, the common reservoir 330 and respirator 340.

The use of two separate fan-filter systems 310a, 310b and two separate airflow circuits in the respirator system 301 provides the following benefits.

Firstly, two smaller fan-filter systems 310a, 310b can be used in place of one larger fan-filter system 310 to provide the required flow rate of filtered air. Each fan 322a, 322b can operate at a lower power than a single fan, while providing the same total flow rate between the two fans 322a, 322b. Two such smaller fan 322a, 322b s together are advantageously much less noisy than one larger fan. For example, two small fans each producing 40 db will be perceived by a user as producing 46 db of noise in total, which corresponds to only a 6 db increase. A single fan operating at double the flow rate would produce a significantly greater noise.

Secondly, using two separate airway paths reduces the extent to which the pressure drops within the respirator 340 when the user 100 inhales. Furthermore, such an arrangement allows smaller first conduits to be used in the respirator system 301.

Thirdly, using two separate airway paths provides redundancy to the respirator system 301. In particular, a level of protection will still be provided even if, for example, one of fans 322a, 322b fails, or one of the airflow circuits become occluded, or if one of the filter mediums 320a, 320b becomes clogged.

Using two fan-filter systems 310a, 310b and hence two airflow pathways arranged on each side of the user' head 101a also offers an advantage in the ease of putting on and taking off the respirator 301. Any adjustment means 361 that might be required to adjust the support 360 to the size of the user' head 101a can be arranged between the fans 310a, 310b, where there is no need for any airflow pathways between the fans 310a, 310b and the respirator 340. This means that the adjustability function does not interfere with the airflow pathways, so that the adjustment means does not break the airflow path from the fans 310a, 310b to the respirator (not visible). The adjustment means 361 may be the type of adjustment means already described above.

In these embodiments, it is advantageous if both fan-filter systems 310a, 310b are powered by a single power supply 313, that is preferably housed in separate housing to each of the fan-filter system 310. In one preferred embodiment, such a power supply 313 is arranged between the two fan-filter systems 310a, 310b on the support 360, i.e. at the rear of the user's neck and below or above the reservoir 330. In this embodiment, the adjusting means 361 takes the form of two tightening straps, each of which is preferably arranged between each fan-filter system 310a, 310b and the power supply 313, as per FIG. 9. When these straps are tensioned so as to reduce the length of the support, the fan-filter system 310a, 310b is moved closer to the power system 313, and the respirator system 301 is thereby secured on the user's head 101a.

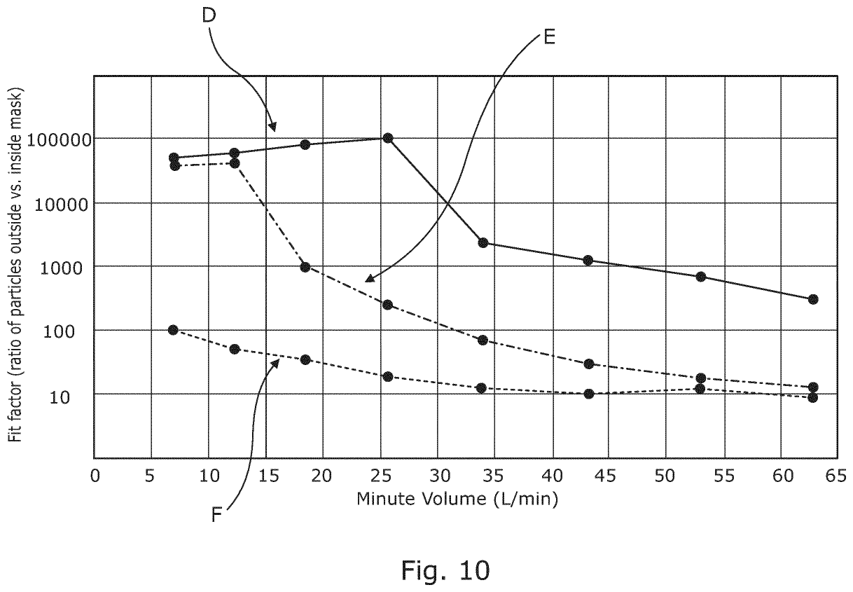

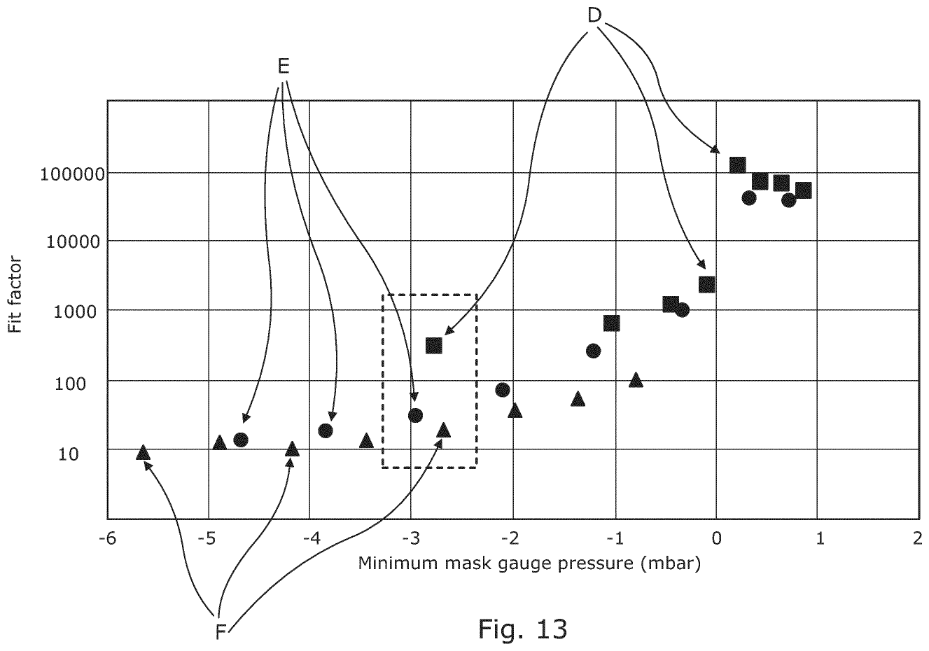

FIGS. 10 to 14 are comparative graphs comparing certain characteristics of a respirator system 1 having the arrangement of FIG. 9 and provided with dual 5V powered fans 310a, 310b and an air reservoir 330, with like characteristics of two other respirator systems. In particular, respirator system 301 (represented by solid line D in FIGS. 10 to 12 and 14 and squares in FIG. 13) is compared against a corresponding respirator system that makes use of dual 5 volt powered fans but no reservoir (represented by dot-dashed line E in FIGS. 10 to 12 and 14 and circles in FIG. 13) and a corresponding respirator system that neither makes use of powered fans, nor a reservoir (represented by dotted line F in FIGS. 10 to 12 and 14 and triangles in FIG. 13).

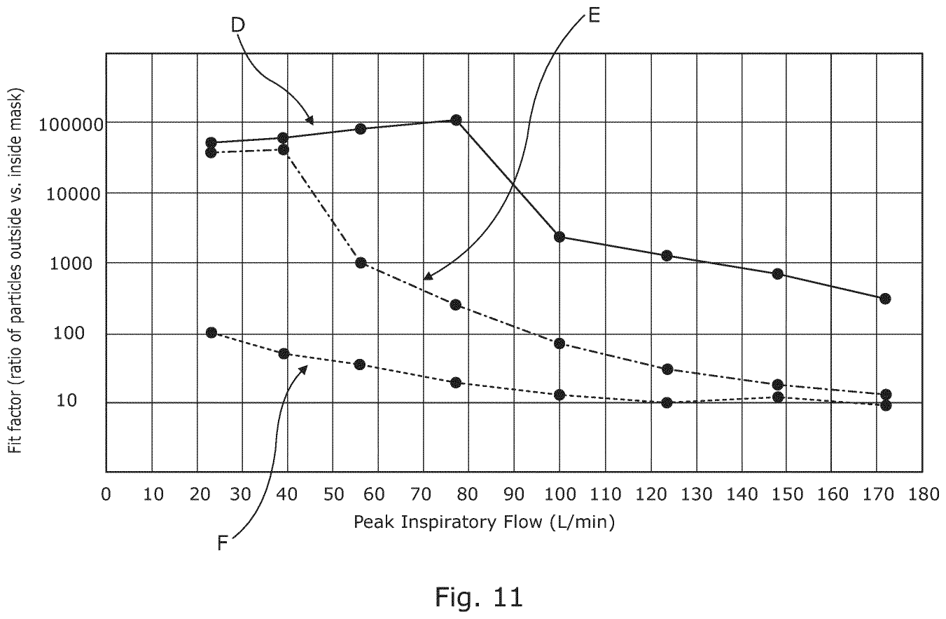

FIGS. 10 and 11 are comparative graphs comparing the fit factor, i.e. the ‘protection factor’, of each respirator system against minute volume and peak inspiratory flow rate respectively. ‘Protection factor’ is the number of harmful particles inside the respirator in use as a proportion of the number of harmful particles in the atmosphere outside the respirator, whereas ‘minute volume’ is the volume of gas inhaled or exhaled in a minute. These data were collected during a breathing simulator assessment. A breathing machine was used to provide the minute volume values (tidal volumes ranged from 0.5 to 2.25 litres, respiratory rate from 14 to 28 breaths/minute) and to provide the peak inspiratory flow rate values, while a Portacount 8040™ (TSI inc) was used to assess the fit factors of the respirator systems. The particles used in this assessment were sodium chloride particles. A leak was set in the respirator system that neither makes use of powered fans nor a reservoir (i.e. the respirator system of dotted line F) so as to achieve a fit factor of 100 under simulated restful breathing.

FIGS. 10 and 11 show how much the use of a reservoir and powered fans improves the protection factor of a respirator system against harmful particles. The effect of the air reservoir on fit factors is pronounced for all breathing demands, whereas the addition of powered fans leads to an improvement in fit factors at low breathing demands but has less influence at higher breathing demands.

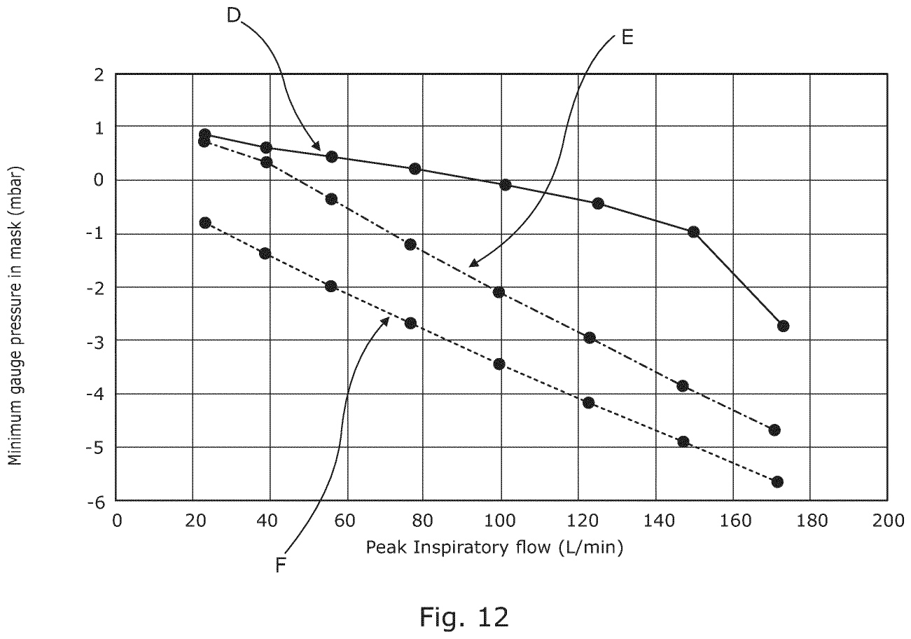

FIG. 12 is a comparative graph comparing minimum gauge pressure in the respirator, i.e. mask, of each respirator system against peak inspiratory flow rate. These data were collected during a breathing simulator assessment. FIG. 12 shows the influence of powered fans and an air reservoir on pressure drop within the respirator of each respirator system during inhalation. The addition of powered fans shifts the curve upwards while the inclusion of the air reservoir reduces the slope. Note the change in slope of the respirator system (represented by solid line D) around 150 l/min is due to collapse of the reservoir under high demand. These graphs illustrate that the positive pressure is more successfully maintained when a reservoir and/or powered fans are present.

FIG. 13 is a comparative graph comparing fit factor, i.e. protection factor, in each respirator system against minimum gauge pressure inside each respirator. FIG. 13 shows a clear relationship between fit factor and minimum gauge pressure in each respirator with lower fit factors recorded at lower respirator pressures. However, it is important to note that fit factors for the respirator system making use of both dual 5V powered fans and an air reservoir (represented by the squares) are higher that those for the other respirator systems (represented by the circles and triangles) at the same minimum mask pressure (see e.g. within the dotted box). The air reservoir is particularly beneficial because it is a compliant bag that provides a lower resistance area than the seal around the respirator. As the user inhales, air is more easily drawn from the low resistance area, i.e. the reservoir, than from the high resistance area, i.e. the seal around the respirator. As a result, the fit is improved.

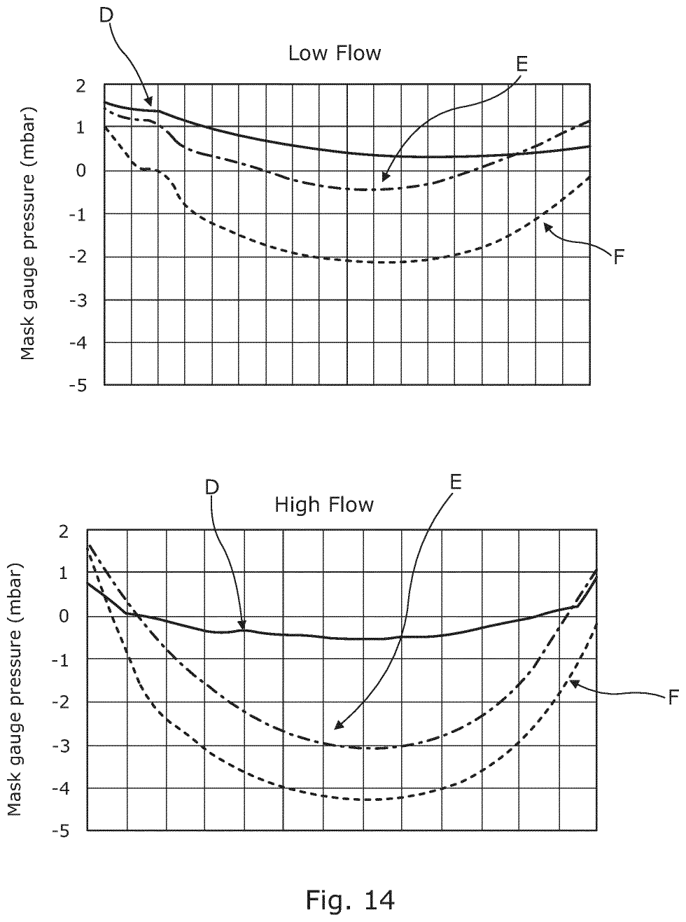

FIG. 14 comprises two comparative graphs comparing respirator (mask) gauge pressure of each respirator system at low (above) and high (below) flows. These data were collected during a breathing simulator assessment. FIG. 12 shows that a system employing both powered fans and an air reservoir markedly attenuates the negative pressure generated in the mask during breathing.

1. A respirator system for delivering filtered atmospheric air to a user for inhalation, the respirator system comprising:
a respirator through which a user can inhale filtered air;
first and second air filter systems, each air filter system being configured to filter and draw air from the atmosphere into the respirator system and to deliver filtered drawn air to the respirator via an airflow path;
first and second conduits for directing filtered air from the respective first and second air filter systems to the respirator; and
a support for supporting the respirator system on the user's head, wherein the respirator is arranged at a front of the support to engage the front of a user's head when in use, and the first and second air filter systems are arranged at the rear of the support to sit at the rear of a user's head when in use,
wherein the support comprises an adjusting means for adjusting a spacing between the two air filter systems to secure the support to the user's head.

2. (canceled)

3. (canceled)

4. (canceled)

5. A respirator system for delivering filtered atmospheric air to a user for inhalation, the respirator system comprising:
a respirator through which a user can inhale filtered air at an inspiratory flow rate;
an air filter system for filtering and drawing air from the atmosphere into the respirator system at a base flow rate and delivering filtered drawn air to the respirator; and
a reservoir for storing filtered air,
wherein the air filter system is arranged in fluid communication with the reservoir and the respirator such that:
when the user's inspiratory flow rate is lower than the base flow rate of the air filter system, at least a portion of the filtered air entering the respirator system is stored in the reservoir; and
when the user's inspiratory flow rate exceeds the base flow rate of the air filter system, filtered air stored in the reservoir is drawn into the respirator for inhalation to supplement the filtered air provided by the air filter system.

6. The respirator system of claim 5 wherein the respirator system is configured such that when the user's inspiratory flow rate is less than or equal to the base flow rate of the filter system, filtered air flows from the air filter system to the respirator for inhalation by the user without supplementation from the reservoir.

7. The respirator system of claim 5, wherein the respirator and air filter system are arranged along a first airflow path, and the reservoir and the air filter system are arranged along a second airflow path, such that the air filter system is common to both airflow paths.

8. The respirator system of claim 7, wherein the first airflow path is uni-directional from the air filter system to the respirator, and wherein the second airflow path is bi-directional from the air filter system to the reservoir and vice versa.

9. The respirator system of claim 5, wherein the respirator system comprises a first conduit arranged to fluidly connect the air filter system to the respirator, and a second conduit arranged to fluidly connect the air filter system to the reservoir.

10. The respirator system of claim 5, wherein the air filter system comprises a junction chamber that is in fluid communication with the reservoir and the respirator, and that is configured to receive the filtered air drawn into the respirator system.

11. The respirator system of claim 10, wherein the junction chamber comprises a manifold that is fluidly connected to the respirator via a first air flow path, and to the reservoir via a second air flow path, such that the manifold is common to both air flow paths.

12. The respirator system of claim 11, wherein the respirator system comprises a first conduit arranged to fluidly connect the manifold to the respirator, a second conduit arranged to fluidly connect the manifold to the reservoir, and a third conduit arranged to fluidly connect the air filter system to the manifold, wherein the second conduit is arranged at an acute angle with respect to the third conduit.

13. (canceled)

14. The respirator system of claim 5, wherein the respirator system comprises first and second air filter systems for filtering and drawing air from the atmosphere into the respirator system at a collective base flow rate, and for delivering filtered drawn air to the respirator through which a user can inhale filtered air at an inspiratory flow rate.

15. The respirator system of claim 14, wherein each of the first and second air filter systems are arranged in fluid communication with the reservoir and the respirator such that: when the user's inspiratory flow rate is lower than the collective base flow rate, at least a portion of the filtered air entering the respirator system is stored in the reservoir; and when the user's inspiratory flow rate exceeds the collective base flow rate, filtered air stored in the reservoir is drawn into the respirator for inhalation to supplement the filtered air provided by the first and second air filter systems.

16. The respirator system of claim 5, wherein the respirator system comprises first and second air filter systems, wherein each air filter system is fluidly connected to the respirator and the reservoir via a separate airflow circuit.

17. The respirator system of claim 5, wherein the respirator system comprises a respirator inlet through which filtered air enters the respirator, and a respirator inlet valve configured to prevent a flow of air through the respirator inlet when the user exhales into the respirator.

18. The respirator system of claim 17, wherein the respirator inlet comprises an opening in a body of the respirator, and the inlet valve is arranged within or adjacent to the opening.

19. The respirator system of claim 5, wherein the reservoir comprises an expandable air bag.

20. The respirator system of claim 5, comprising a first conduit arranged to fluidly connect the air filter system to the respirator, a second conduit arranged to fluidly connect the air filter system to the reservoir, and a support for securing the respirator to a user's face by extension around the user's head, wherein the respirator is secured to a forward portion of the support and the filter system is secured to a rearward portion of the support, wherein the first conduit is incorporated into the support, wherein the second conduit is arranged to depend downwardly from the filter system when the respirator system is arranged for use, with the reservoir arranged at the bottom of the second conduit.

21. (canceled)

22. (canceled)

23. The respirator system of claim 5, wherein the respirator is configured to seal around the user's nose and/or mouth area such that an air cavity is defined between the respirator and the user's face for receiving filtered air from the filter system and/or reservoir.

24. The respirator system of claim 5, wherein the respirator comprises a respirator outlet through which exhaled air can exit the respirator, and an outlet valve arranged in or adjacent to the respirator outlet, wherein the outlet valve is configured to permit air flow out of the respirator when the user exhales and to prevent air flow into the respirator from the atmosphere.

25. The respirator system of claim 5, wherein the respirator system comprises a power supply, wherein the power supply comprises a battery.

26. (canceled)

27. A method of delivering filtered atmospheric air to a user for respiration, the method comprising:
drawing air from the atmosphere into a respirator system at a base flow rate,
filtering the drawn air, and
delivering drawn filtered air to the user for inhalation,
the method further comprising:
when a user inspiration rate is less than the base flow rate, delivering drawn filtered air to a reservoir for storage, and
when the user inspiration rate exceeds the base flow rate, supplementing the drawn filtered air delivered to the user with stored filtered air from the reservoir.

28. (canceled)

29. (canceled)
